(19) United States
(12) Patent Application Publication
(10) Pub. No.: US 2011/0312321 A1
(43) Pub. Date: Dec. 22, 2011

(54) SYSTEM, APPARATUS, AND METHOD FOR IMPROVING CIRCUIT SWITCHED FALLBACK CALL SETUP DELAY IN WIRELESS COMMUNICATION SYSTEMS

(75) Inventors: Shyamal Ramachandran, San Diego, CA (US); Thomas Klingenbrunn, San Diego, CA (US)

(73) Assignee: QUALCOMM Incorporated, San Diego, CA (US)

(21) Appl. No.: 13/165,684

(22) Filed: Jun. 21, 2011

Related U.S. Application Data
(60) Provisional application No. 61/357,441, filed on Jun. 22, 2010.
(60) Provisional application No. 61/359,505, filed on Jun. 29, 2010.

(51) Int. Cl. H04W 88/16; H04W 60/00

(52) U.S. Cl. 455/426.1

(57) ABSTRACT

In accordance with aspects of the disclosure, a method, apparatus, and computer program product are provided for wireless communication. The method, apparatus, and computer program product may be configured to determine whether a device is switching from a first radio access technology to a second radio access technology to perform a circuit switched call setup process and determine whether at least one of a circuit switched domain registration procedure and a packet switched domain registration procedure is to be performed on the second radio access technology.

### CROSS-REFERENCE TO RELATED APPLICATION(S)

This application claims priority to and benefit of U.S. Provisional Application Ser. No. 61/357,441, entitled “Method and Apparatus for Improving Circuit Switched Fallback Call Setup Delay,” filed on Jun. 22, 2010, which is expressly incorporated by reference herein in its entirety.

This application also claims priority to and benefit of U.S. Provisional Application Ser. No. 61/359,505, entitled “Method and Apparatus for Improving Circuit Switched Fallback Call Setup Delay,” filed on Jun. 29, 2010, which is expressly incorporated by reference herein in its entirety.

### BACKGROUND

1. Field

The present disclosure relates generally to communication systems, and more particularly, to techniques for supporting circuit switched (CS) fallback (CSFB) in Long Term Evolution (LTE) network, and improving CSFB call setup delay.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (I′D-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In accordance with an aspect of the disclosure, a method to facilitate wireless communication comprises determining whether a device is switching from a first radio access technology to a second radio access technology to perform a circuit switched call setup process and determining whether at least one of a circuit switched domain registration procedure and a packet switched domain registration procedure is to be performed on the second radio access technology. The method may comprise performing the circuit switched domain registration procedure or a circuit switched call setup procedure in parallel with the packet switched domain registration procedure based on the determination that the device is switching radio access technologies to implement the circuit switched call setup process. The method may comprise performing the circuit switched domain registration procedure in series with the packet switched domain registration procedure based on the determination that the device is not switching radio access technologies to implement the circuit switched call setup process.

In accordance with an aspect of the disclosure, an apparatus for wireless communication comprises a processing system configured to determine whether a device is switching from a first radio access technology to a second radio access technology to perform a circuit switched call setup process and determine whether at least one of a circuit switched domain registration procedure and a packet switched domain registration procedure is to be performed on the second radio access technology. The processing system may be configured to perform the circuit switched domain registration procedure or a circuit switched call setup procedure in parallel with the packet switched domain registration procedure based on the determination that the device is switching radio access technologies to implement the circuit switched call setup process. The processing system may be configured to perform the circuit switched domain registration procedure in series with the packet switched domain registration procedure based on the determination that the device is not switching radio access technologies to implement the circuit switched call setup process.

In accordance with an aspect of the disclosure, an apparatus for wireless communication comprises means for determining whether a device is switching from a first radio access technology to a second radio access technology to perform a circuit switched call setup process and means for determining whether at least one of a circuit switched domain registration procedure and a packet switched domain registration procedure is to be performed on the second radio access technology. The apparatus may comprise means for performing the circuit switched domain registration procedure or a circuit switched call setup procedure in parallel with the packet switched domain registration procedure based on the determination that the device is switching radio access technologies to implement the circuit switched call setup process. The apparatus may comprise means for performing the circuit switched domain registration procedure in series with the packet switched domain registration procedure based on the determination that the device is not switching radio access technologies to implement the circuit switched call setup process.

In accordance with an aspect of the disclosure, a computer program product comprises a computer-readable medium comprising code executable by an apparatus to determine whether a device is switching from a first radio access technology to a second radio access technology to perform a circuit switched call setup process and determine whether at least one of a circuit switched domain registration procedure and a packet switched domain registration procedure is to be performed on the second radio access technology. The computer-readable medium may comprise code executable by the apparatus to perform the circuit switched domain registration procedure or a circuit switched call setup procedure in parallel with the packet switched domain registration procedure based on the determination that the device is switching radio access technologies to implement the circuit switched call setup process. The computer-readable medium may comprise code executable by the apparatus to perform the circuit switched domain registration procedure in series with the packet switched domain registration procedure based on the determination that the device is not switching radio access technologies to implement the circuit switched call setup process.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows a diagram illustrating a wireless communication network, in accordance with aspects of the disclosure.

FIG. 2 shows a diagram illustrating an access network, in accordance with aspects of the disclosure.

FIGS. 3A and 3B show diagrams illustrating various process flows of a communication network, in accordance with aspects of the disclosure.

FIG. 4 shows a diagram illustrating a call flow of an application of call setup process, in accordance with aspects of the disclosure.

FIG. 5 shows another diagram illustrating a call flow of an application of call setup process, in accordance with aspects of the disclosure.

FIG. 6 shows a diagram illustrating an embodiment of a hardware implementation for an apparatus employing a processing system, in accordance with aspects of the disclosure.

FIG. 7 shows a diagram depicting an example of field data associated with call setup delay times, in accordance with aspects of the disclosure.

FIG. 8 shows a diagram illustrating an embodiment of a process flow for a method of utilizing network access parameters in wireless communication systems, in accordance with aspects of the disclosure.

FIG. 9 shows a diagram illustrating an embodiment of functionality of an apparatus configured to facilitate wireless communication, in accordance with aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented utilizing electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

The techniques described herein may be utilized for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often utilized interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is utilized in much of the description below.

In an aspect of the disclosure, when a phone number is dialed to place a CS call, if the UE were camped on an LTE network, a circuit switched fallback (CSFB) procedure may be employed. The CSFB procedure may move the UE from an LTE cell to a CS based cell, such as UTRAN, GERAN, etc., where the CS call setup may occur using legacy CS call setup procedures. Further, moving the UE from LTE cell to the CS based cell (e.g., UTRAN/GERAN) takes some processing time on both the UE side and the network side. This processing time may contribute the call setup delay experienced by a user who placed the call.

Aspects of the disclosure provide for determining whether User Equipment (UE) should perform separate parallel Packet Switched (PS) and Circuit Switched (CS) procedures or a combined PS and CS registration procedure.

In an embodiment, if the UMTS network is NMO1 and both Routing Area (RA) update and Location Area (LA) update are needed, then the UE may be configured to perform the following. For instance, if LTE to UMTS transition was due to a CSFB procedure, then the UE performs CS registration and PS registration procedures in parallel. Once the CS registration procedure is complete, the UE resumes CS call setup. In another instance, if LTE to UMTS transition was not due to a CSFB procedure, then the UE performs combined PS and CS registration procedure.

In another embodiment, if the UMTS network is NMO1 and only RA update is needed, then the UE may be configured to perform the following. For instance, if LTE to UMTS transition was due to a CSFB procedure, then the UE performs CS call setup and PS registration procedures in parallel. In another instance, if LTE to UMTS transition was not due to a CSFB procedure, then the UE performs combined PS and CS registration procedure.

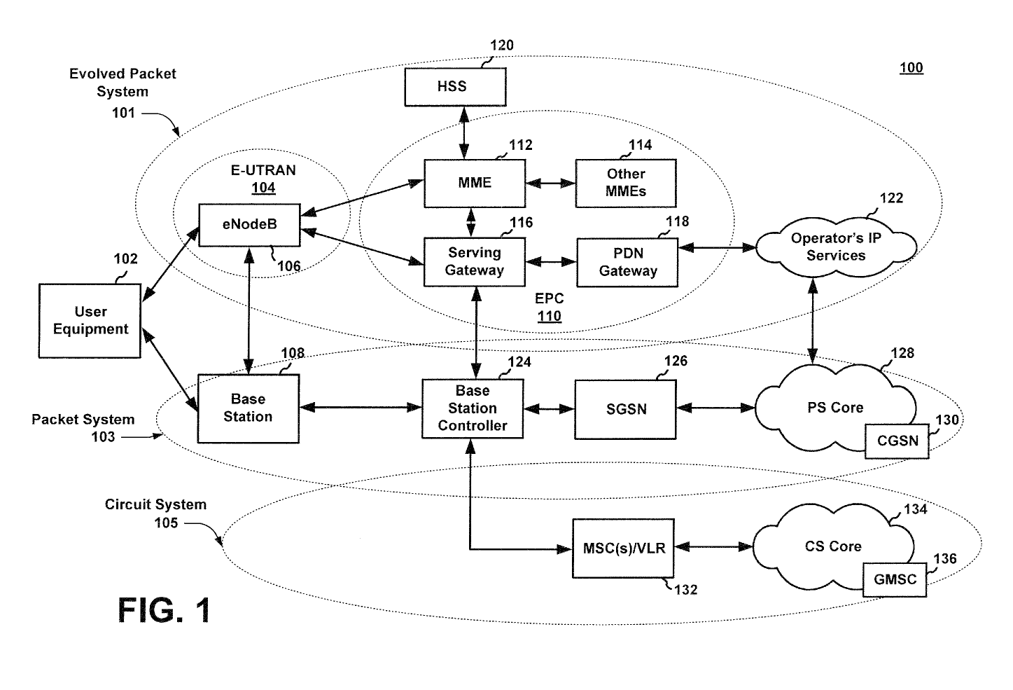

FIG. 1 shows a diagram illustrating a wireless network architecture 100 employing various apparatuses, in accordance with aspects of the disclosure. The network architecture 100 may include an Evolved Packet System (EPS) 101. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS may interconnect with other access networks, such as a packet switched core (PS core) 128, a circuit switched core (CS core) 134, etc. As shown, the EPS provides packet-switched services, however, as those skilled in the art will readily appreciate, the various concepts presented throughout this disclosure may be extended to networks providing circuit-switched services, such as the network associated with CS core 134.

The network architecture 100 may further include a packet switched network 103 and a circuit switched network 105. In one aspect, the packet switched network 103 may include base station 108, base station controller 124, Serving GPRS Support Node (SGSN) 126, PS core 128 and Combined GPRS Service Node (CGSN) 130. In another aspect, the circuit switched network 105 may include base station 108, base station controller 124, Mobile services Switching Centre (MSC), Visitor location register (VLR) 132, CS core 134 and Gateway Mobile Switching Centre (GMSC) 136.

The E-UTRAN may include an evolved Node B (eNB) 106 and connection to other networks, such as packet and circuit switched networks may be facilitated through base station 108. The eNB 106 provides user and control plane protocol terminations toward the UE 102. The eNB 106 may be connected to the other eNBs 108 via an X2 interface (i.e., backhaul). The eNB 106 may also be referred to by those skilled in the art as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 include the Internet, the Intranet, an IP Multimedia Subsystem (IMS), and a PS Streaming Service (PSS).

In an aspect of the disclosure, the wireless system 100 may be enabled to facilitate circuit switched fallback (CSFB). As used herein, CSFB may refer to establishing a signaling channel between a circuit switched MSC 132 and the LTE core network 101 to allow for services, such as voice calls, short message service (SMS), etc. In an implementation, when a UE 102 is moved from an LTE network 101 to a 3GPP network, such as a CS based network 103 (UTRAN), a packet switched (PS) network 103, etc., the UE may perform in one or more registration procedures prior to being able to communicate user data over the 3GPP network. If the transition from LTE network 101 to a CS based network 105 is a result of a CS call origination using a CSFB procedure, the registration procedures may add significant additional delays to the overall call setup delay. In one aspect, a reason behind delays as a result of registration is obtaining authentication during registration procedures. It should be appreciated that, while registration procedures may be unavoidable and may enable proper operation of a network, there may be benefits to processing registration procedures and call setup procedures contemporaneously.

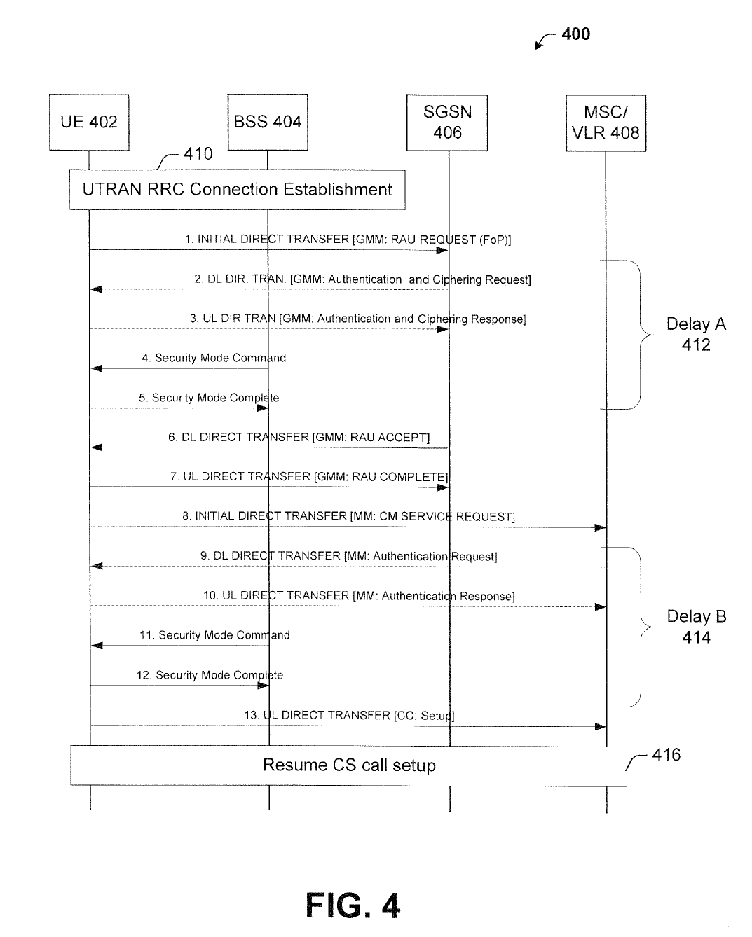

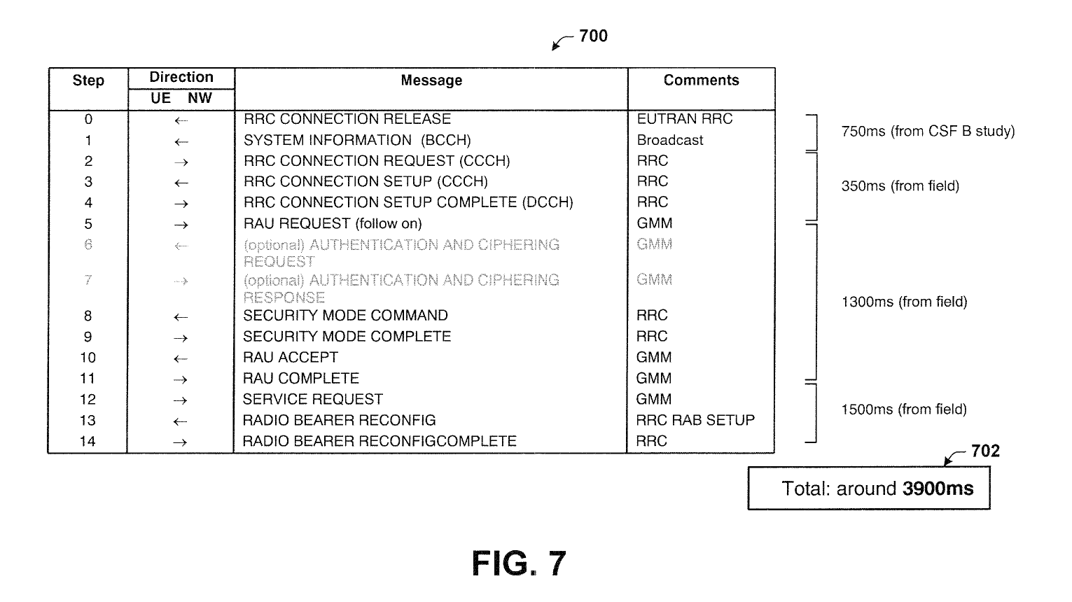

In one aspect, a mobility trigger may be used to determine whether a registration procedure and a call setup procedure may be performed substantially in series or contemporaneously (e.g., in parallel). Generally, if a UE 102 enters a CS based network 105 operating in network mode operation I (NMO I), the standard behavior of the UE may be to perform combined Routing Area/Location Area (RA/LA) update procedure. After this procedure is complete, the UE may resume CS call setup. This sequence of procedures is shown in FIG. 4. In such an aspect, the RA Update (RAU) procedure may result in security procedures in the PS domain resulting in Delay A. Further, the CS call setup procedure may result in security procedures in the CS domain resulting in Delay B. As such, the call setup may occur only after Delay A and Delay B are accounted for. In other words, Delay A and Delay B are serialized thereby increasing the overall call setup delay. In operation, Delay A may be of an order of greater than a second. Such a delay may account for approximating 20% to 25% of overall call setup delay. Further examples of field data associated with the delays are provided in FIG. 7. Reducing delay time may provide a competitive edge in implementation. Additionally, one may note that signaling overhead associated with a substantially series approach may be lower than other approaches.

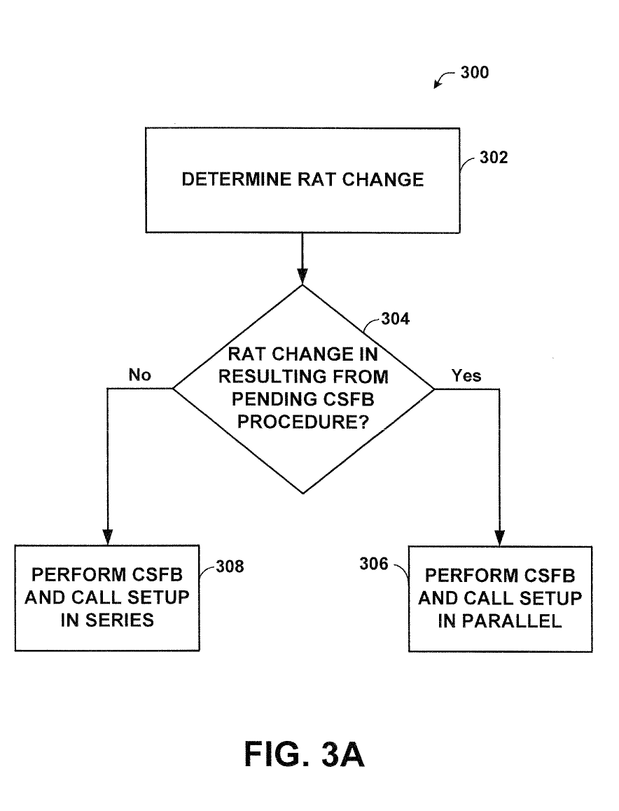

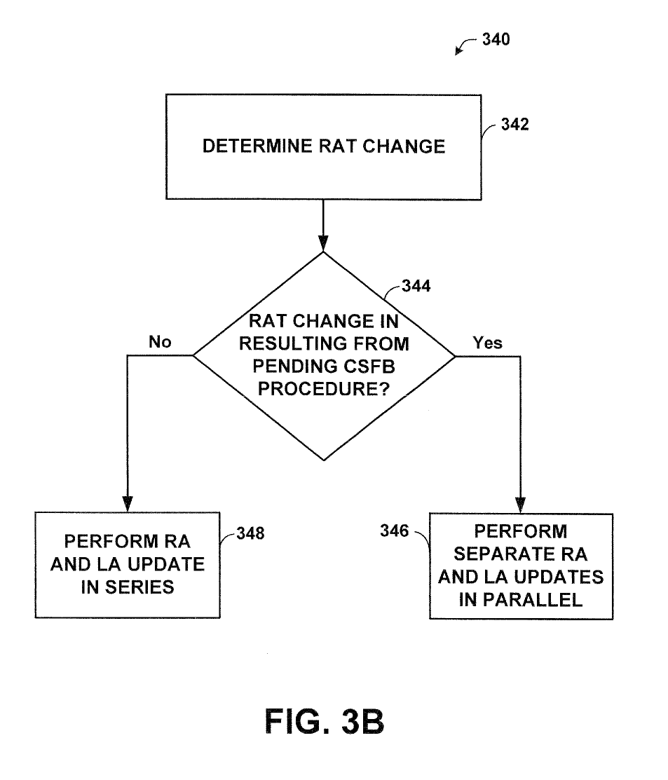

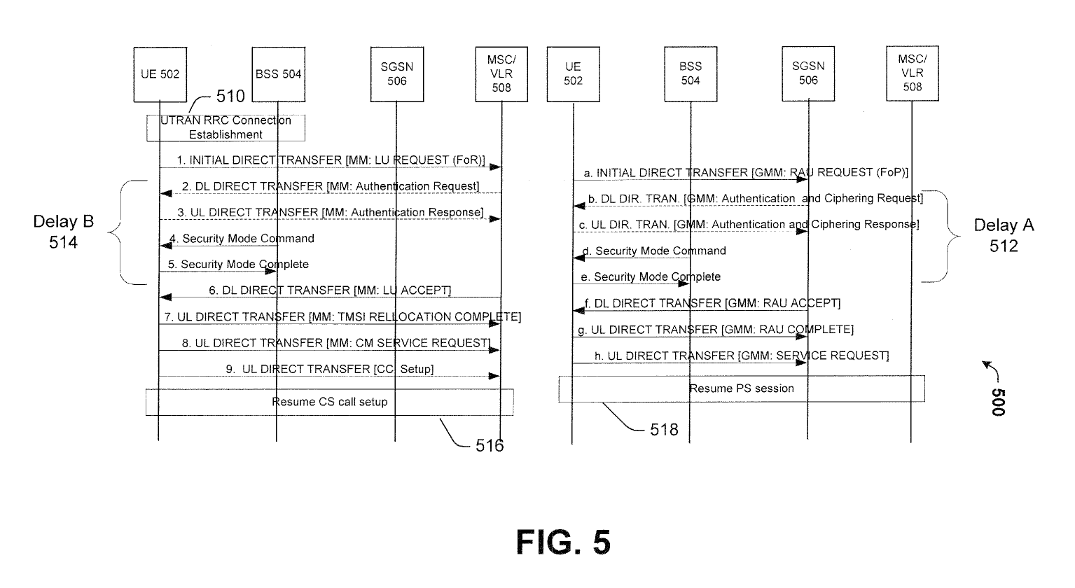

Further discussions of processes that allow an apparatus, such as UE 102, to setup CSFB are provided with reference to FIGS. 3A, 3B, 4, and 5. In an aspect of the disclosure, instead of performing the procedure in FIG. 4, if the UE 102 was to perform the contemporaneous call setup procedures shown in FIG. 5, the UE 102 may continue call setup by incurring Delay B, wherein the overall call setup delay may no longer be affected by Delay A. However, in an example, signaling overhead associated with the contemporaneous call setup procedures shown in FIG. 5 may be greater than that observed in reference to the process described with reference to FIG. 4.

In an aspect of the disclosure, although the description may provide examples through use of a UTRAN system, it should be appreciated that other RATs, such as GERAN, etc., may be used.

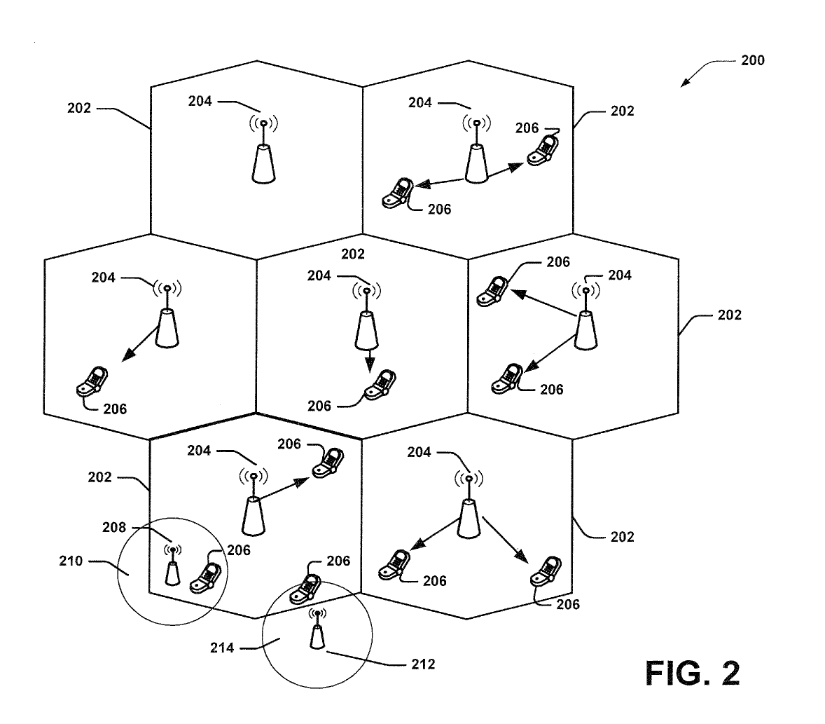

FIG. 2 shows a diagram illustrating an access network in an LTE network architecture, in accordance with aspects of the disclosure. In an example, the access network 200 is divided into a number of cellular regions (cells) 202. One or more lower power class eNBs 208, 212 may have cellular regions 210, 214, respectively, that overlap with one or more of the cells 202. The lower power class eNBs 208, 212 may be femto cells (e.g., home eNBs (HeNBs)), pico cells, or micro cells. A higher power class or macro eNB 204 is assigned to a cell 202 and is configured to provide an access point to the EPC 210 for all the UEs 206 in the cell 202. There is no centralized controller in this example of an access network 200, but a centralized controller may be used in alternative configurations. The eNB 204 is responsible for all radio related functions including radio bearer control, admission control, mobility control, scheduling, security, and connectivity to the serving gateway 216 (see FIG. 1).

In accordance with aspects of the disclosure, the modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 2rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

In an implementation, the eNB 204 may have multiple antennas supporting MIMO technology. The use of MIMO technology enables the eNB 204 to exploit the spatial domain to support spatial multiplexing, beamforming, and transmit diversity.

Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream and then transmitting each spatially precoded stream through a different transmit antenna on the downlink. The spatially precoded data streams arrive at the UE(s) 206 with different spatial signatures, which enables each of the UE(s) 226 to recover the one or more data streams destined for that UE 206. On the uplink, each UE 206 transmits a spatially precoded data stream, which enables the eNB 204 to identify the source of each spatially precoded data stream.

Spatial multiplexing may be generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

FIGS. 3A and 3B show diagrams illustrating various process flows of a communication network, in accordance with aspects of the disclosure. For purposes of simplicity of explanation, methodologies are shown and described as a series of acts; however, it should be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram.

Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

In an aspect of the disclosure, referring to FIG. 3A, a system 300 is shown, which may include a UE and a multiple cells. At reference numeral 302, the UE may be informed of a RAT change. In an example, the UE non-access stratum (NAS) layer is informed of a radio access technology (RAT) change (e.g., from LTE to UTRAN), and is further informed that the 3GPP cell is operating in NMO I. As such, a mobility trigger may be activated. Additionally, or in the alternative, another mobility trigger may be that the UE is LTE enabled, and as such is capable of performing contemporaneous processing, as shown in FIG. 5. At reference numeral 304, it may be determined whether a there is a pending circuit switched fallback (CSFB) procedure. The UE behavior may depend on whether or not the RAT change occurred during a pending CSFB procedure (for example a enhance management service request (ESR) procedure). If, at reference numeral 304, it is determined through analysis of the mobility trigger, that there is a pending CSFB procedure, then at reference numeral 306 the CSFB procedure and a call setup procedure may be performed contemporaneously, as shown in FIG. 5. By contrast, if at reference numeral 304 it is determined that there is no pending CSFB procedure, then at reference numeral 308, a cell setup procedure may be performed substantially in series, as shown in FIG. 4.

In an aspect of the disclosure, referring to FIG. 3B, a system 340 is shown, which may include a UE and a multiple cells. At reference numeral 342, the UE may be informed of a RAT change. In an example, the UE non-access stratum (NAS) layer is informed of a radio access technology (RAT) change (e.g., from LTE to UTRAN), and is further informed that the 3GPP cell is operating in NMO I. As such, a mobility trigger may be activated. Additionally, or in the alternative, another mobility trigger may be that the UE is LTE enabled and, as such, is capable of performing contemporaneous processing, as shown in FIG. 5. At reference numeral 304, it may be determined whether a there is a pending circuit switched fallback (CSFB) procedure. The UE behavior may depend on whether or not the RAT change occurred during a pending CSFB procedure (e.g., an extended service request (ESR) procedure). If, at reference numeral 304, it is determined through analysis of the mobility trigger, that there is a pending CSFB procedure with at least one of a Routing Area (RA) and a Location Area (LA) updating procedures to be performed prior to CS call setup, then at reference numeral 346, either both the RA and LA updating may be performed contemporaneously, or the RA and CS call setup may be performed contemporaneously as shown in FIG. 5. By contrast, if, at reference numeral 304, it is determined that there is no pending CSFB procedure, then at reference numeral 348, a cell setup procedure may be performed substantially in series with at least one of an RA or LA update process, as shown in FIG. 4.

FIG. 4 shows a diagram illustrating a call flow of an application of call setup process, in accordance with aspects of the disclosure. In an example, the call flow diagram is operable for supporting peer to place communications in a communications system 400. The communication system 400 may include a UE 402, a BSS 404, a SGSN 406, and a MSC/VLR 408. It may be noted that the below described process may be implemented on various different networks, such as UTRAN, GERAN, etc. At sequence step 410, a UTRAN radio resource control connection may be established. Thereafter, at sequence step 412, delay A occurs associated with RAU messaging. At sequence step 414, delay B may occur associated with various authentication messages. Once delay A and delay B have been completed, at sequence step 416, CS call setup may be resumed.

FIG. 5 shows a diagram illustrating a call flow of an application of call setup process, in accordance with aspects of the disclosure. In an example, the call flow diagram is operable for supporting peer to place communications in a communications system 500. The communication system 500 may include a UE 502, a BSS 504, a SGSN 506, and a MSC/VLR 508. Further, it may be noted that sequence steps described herein may be performed in parallel and/or substantially contemporaneously. At sequence step 510, a UTRAN radio resource control connection may be established. Thereafter, at sequence step 412, delay A occurs associated with RAU messaging. Contemporaneously, at sequence step 514, delay B may occur associated with various authentication messages. Once delay A and delay B have been completed, at sequence step 516, CS call setup may he resumed, and at sequence step 518 a PS session may be resumed.

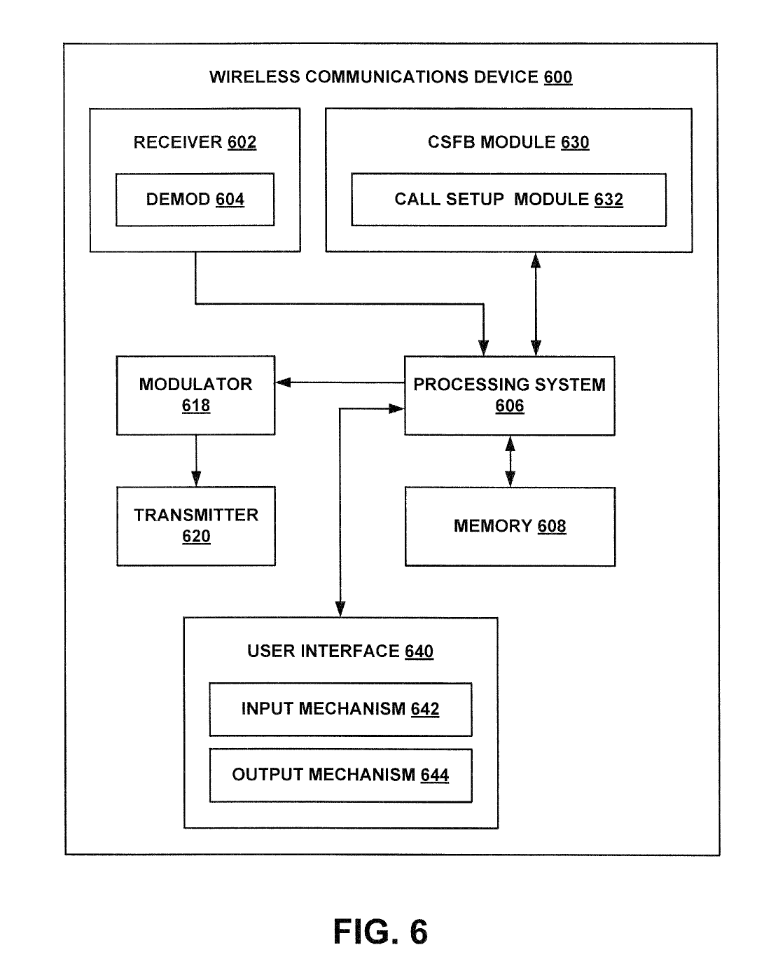

FIG. 6 shows a diagram illustrating an embodiment of a hardware implementation for an apparatus 600 employing a processing system, in accordance with aspects of the disclosure. In an implementation, the apparatus 600 comprises an example of the wireless communication device 102 of FIG. 1. As shown in FIG. 6, the wireless communication device 600 comprises a receiver 602 that receives a signal from, for instance, a receive antenna (not shown), performs typical actions on (e.g., filters, amplifies, downconverts, etc.) the received signal, and digitizes the conditioned signal to obtain samples. The receiver 602 may comprise a demodulator 604 that may demodulate received symbols and provide them to a processing system 606 for channel estimation. The processing system 606 may comprise one or more processors configured for analyzing information received by the receiver 602 and/or for generating information for transmission by a transmitter 620. The processing system 606 may comprise one or more processors configured to control one or more components of the wireless communication device 600. The processing system 606 may comprise one or more processors configured to analyze information received by the receiver 602, generate information for transmission by the transmitter 620, and/or control one or more components of the wireless communication device 600.

The wireless communication device 600 may comprise a memory 608 that is operatively coupled to the processing system 606 and that may store data to be transmitted, received data, information related to available channels, data associated with analyzed signal and/or interference strength, information related to an assigned channel, power, rate, or the like, and any other suitable information for estimating a channel and communicating via the channel. Memory 608 may additionally store protocols and/or algorithms associated with estimating and/or utilizing a channel (e.g., performance based, capacity based, etc.).

In an aspect of the disclosure, the processing system 606 may provide means for determining if a device is switching from a first radio access technology (RAT) to a second RAT to implement a mobile terminated (MT) CS fallback (CSFB) process; and means for processing a CSFB setup procedure contemporaneously with a call setup procedure, when it is determined that the device is switching RATS to implement the MT CSFB process; or means for processing a CSFB setup procedure in series with a call setup procedure, when it is determined that the device is not switching RATS to implement the MT CSFB process.

In another aspect of the disclosure, the processing system 606 may provide means for determining if a device is switching from a first radio access technology (RAT) to a second RAT to execute a CS call setup process, means for determining if at least one of CS and PS domain registration procedures need to be performed on the second RAT, and means for performing at least one of the CS domain registration procedures or a CS call setup procedure contemporaneously with the PS domain registration procedure, when it is determined that the device is switching RATs to implement the CS call setup process, or means for performing at least one of the CS domain registration procedures or a CS call setup procedure in series with the PS domain registration procedure, when it is determined that the device is not switching RATS to implement the CS call setup process.

It will be appreciated that a data store (e.g., memory 608) described herein may be either volatile memory or nonvolatile memory, or may include both volatile and nonvolatile memory. By way of illustration, and not limitation, nonvolatile memory may include read only memory (ROM), programmable ROM (PROM), electrically programmable ROM (EPROM), electrically erasable PROM (EEPROM), or flash memory. Volatile memory may include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 608 of the subject systems and methods may comprise, without being limited to, these and any other suitable types of memory.

The wireless communication device 600 may further include a CSFB module 630 to facilitate enabling MT CSFB call setup up for the wireless communication device 600. In one aspect, the CSFB module 630 may include a call setup module 632. In an implementation, the call setup module 632 may be operable to detect if a mobility trigger has been activated. In another implementation, the UE non-access stratum (NAS) layer is informed of a radio access technology (RAT) change (e.g., from LTE to UTRAN), and is further informed that the 3GPP cell is operating in NMO I. As such, a mobility trigger may be activated. Additionally, or in the alternative, another mobility trigger may be that the UE is LTE enabled, and as such is capable of performing contemporaneous processing, as shown in FIG. 5. The UE behavior may depend on whether or not the RAT change occurred during a pending CSFB procedure (for example a enhance management service request (ESR) procedure). If it is determined through analysis of the mobility trigger, that there is a pending CSFB procedure, then the CSFB procedure and a call setup procedure may be performed contemporaneously, as shown in FIG. 5. By contrast, if it is determined that there is no pending CSFB procedure, then a cell setup procedure may be performed substantially in series, as shown in FIG. 4.

Additionally, the wireless communication device 600 may include a user interface 640. The user interface 640 may include an input mechanism 642 for generating inputs into the wireless communication device 600, and an output mechanism 642 for generating information for consumption by the user of the wireless communication device 600. In an implementation, the input mechanism 642 may include a mechanism such as a key or keyboard, a mouse, a touch-screen display, a microphone, etc. In another implementation, the output mechanism 644 may include a display, an audio speaker, a haptic feedback mechanism, a Personal Area Network (PAN) transceiver etc. In the illustrated aspects, the output mechanism 644 may include a display operable to present media content that is in image or video format or an audio speaker to present media content that is in an audio format.

FIG. 7 shows a diagram depicting an example of field data associated with call setup delay times, in accordance with aspects of the disclosure. In an example, data interruption time for LTE to 3GGP based cell redirection (with PS only) may be approximately 3-4 seconds. While, data interruption time for LTE to 3GGP based cell redirection (CS fallback+PS) may be approximately 4-5 seconds.

As shown in FIG. 7, various processes associated with call setup may result in a delay of 3900 ms (702). In one aspect, the 3900 ms includes an optional authentication process and avoiding such a process may save up to 500 ms). Further, additional time saves may be obtained through use of idle mode signalling reduction (ISR) (e.g., ISR may save up to 500 ms by avoiding the RAU procedure). In one aspect, between items 0 and 14, data may be interrupted. Thereafter, data communication may resume after item 14. Further, using a Combined RAU/LAU procedure, an RAU and LAU may triggered at substantially the same time and progress contemporaneously (e.g., in parallel). However, the RAU in a combined RAU/LAU may be held up by the LAU procedure if LAU takes longer than RAU. Further, UE processing of both CS and PS setup may take slightly longer than PS setup alone. However, in operation, a delay bottleneck may mostly be attributed to waiting for network responses. Overall such delays may not be expected to add more than a few hundred milliseconds. In one aspect, there may be signal radio bearer (SRB) bandwidth limitation when CS and PS call setup are contending for a SRB. As similarly noted above, an expected delay of a few hundred milliseconds may be expected if a 13 kbps SRB is used. Generally, CSFB data interruption may be within +1 second compared to PS redirection case.

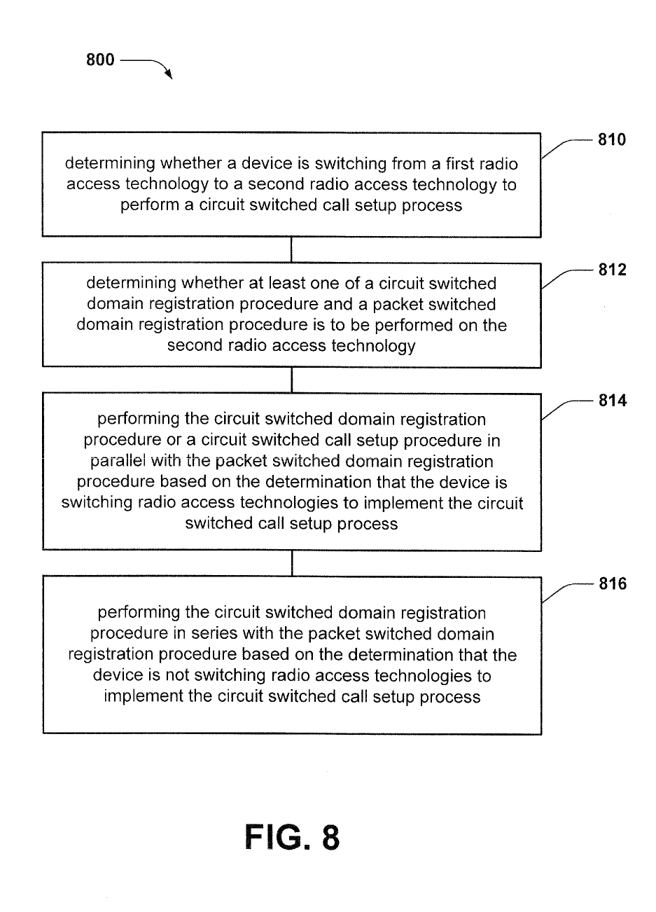

FIG. 8 shows a diagram 800 illustrating an embodiment of a process flow for a method of utilizing network access parameters in wireless communication systems, in accordance with aspects of the disclosure.

Referring to FIG. 8, at 810, the method is configured for determining whether a device is switching from a first radio access technology to a second radio access technology to perform a circuit switched call setup process. At 812, the method is configured for determining whether at least one of a circuit switched domain registration procedure and a packet switched domain registration procedure is to be performed on the second radio access technology. At 814, the method is configured for performing the circuit switched domain registration procedure or a circuit switched call setup procedure in parallel with the packet switched domain registration procedure based on the determination that the device is switching radio access technologies to implement the circuit switched call setup process. At 816, the method is configured for performing the circuit switched domain registration procedure in series with the packet switched domain registration procedure based on the determination that the device is not switching radio access technologies to implement the circuit switched call setup process.

In an implementation, the circuit switched domain registration procedure and the packet switched domain registration procedure may be performed in series by invoking a combined routing area update procedure.

In an implementation, the circuit switched domain registration procedure and the packet switched domain registration procedure may be performed in parallel by invoking a location update procedure for circuit switched domain registration and routing area update procedure for packet switched domain registration.

In an implementation, the circuit switched call setup procedure may comprise a circuit switched fallback procedure. The first radio access technology may be used in an evolved packet network. The first radio access technology may comprise Long Term Evolution (LTE) radio access technology. The second radio access technology may be used in at least one of a circuit switched network and a packet switched network. The second network may comprise a UMTS based network or a GSM based network.

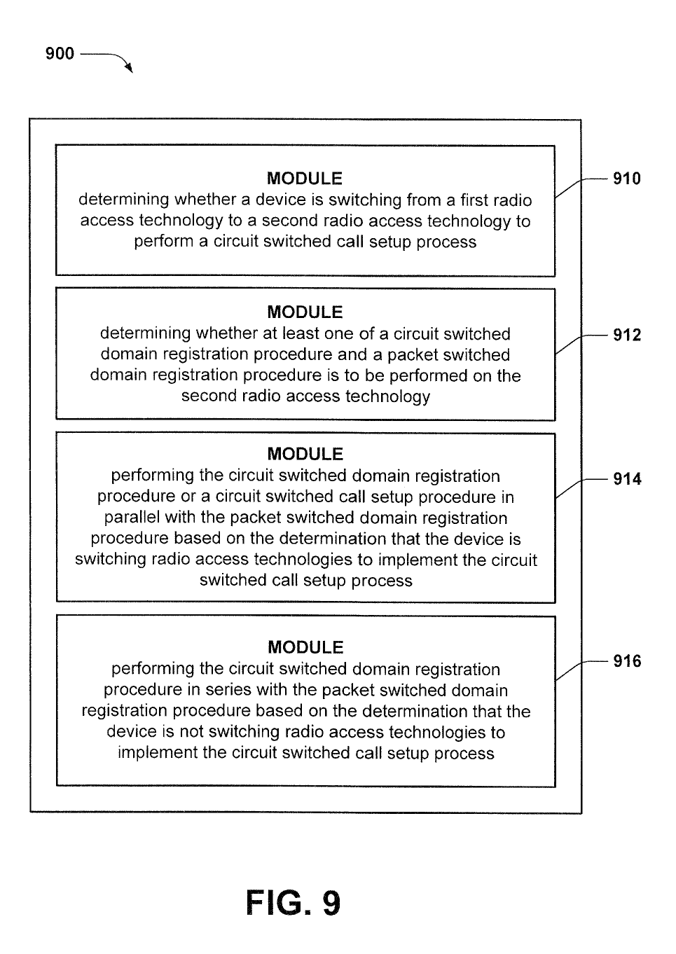

FIG. 9 shows a diagram 900 illustrating an embodiment of functionality of an apparatus (e.g., apparatus 600 of FIG. 6) configured to facilitate wireless communication, in accordance with aspects of the disclosure.

The apparatus includes a module 910 configured for determining whether a device is switching from a first radio access technology to a second radio access technology to perform a circuit switched call setup process. The apparatus includes a module 912 configured for determining whether at least one of a circuit switched domain registration procedure and a packet switched domain registration procedure is to be performed on the second radio access technology. The apparatus includes a module 914 configured for performing the circuit switched domain registration procedure or a circuit switched call setup procedure in parallel with the packet switched domain registration procedure based on the determination that the device is switching radio access technologies to implement the circuit switched call setup process. The apparatus includes a module 916 configured for performing the circuit switched domain registration procedure in series with the packet switched domain registration procedure based on the determination that the device is not switching radio access technologies to implement the circuit switched call setup process. The apparatus may include additional modules that perform each of the steps in the aforementioned flow charts. As such, each step in the aforementioned flow charts may be performed by a module and the apparatus may include one or more of those modules.

In an implementation, the circuit switched domain registration procedure and the packet switched domain registration procedure may be performed in series by invoking a combined routing area update procedure.

In an implementation, the circuit switched domain registration procedure and the packet switched domain registration procedure may be performed in parallel by invoking a location update procedure for circuit switched domain registration and routing area update procedure for packet switched domain registration.

In an implementation, the circuit switched call setup procedure may comprise a circuit switched fallback procedure. The first radio access technology may be used in an evolved packet network. The first radio access technology may comprise Long Term Evolution (LTE) radio access technology. The second radio access technology may be used in at least one of a circuit switched network and a packet switched network. The second network may comprise a UMTS based network or a GSM based network.

Referring to FIG. 6, in a configuration, the apparatus 600 for wireless communication comprises the processing system 606 configured to provide a means for determining whether a device is switching from a first radio access technology to a second radio access technology to perform a circuit switched call setup process and a means for determining whether at least one of a circuit switched domain registration procedure and a packet switched domain registration procedure is to be performed on the second radio access technology. The processing system 606 may be configured to provide a means for performing the circuit switched domain registration procedure or a circuit switched call setup procedure in parallel with the packet switched domain registration procedure based on the determination that the device is switching radio access technologies to implement the circuit switched call setup process. The processing system 606 may be configured to provide a means for performing the circuit switched domain registration procedure in series with the packet switched domain registration procedure based on the determination that the device is not switching radio access technologies to implement the circuit switched call setup process.

In an implementation, the circuit switched domain registration procedure and the packet switched domain registration procedure may be performed in series by invoking a combined routing area update procedure.

In an implementation, the circuit switched domain registration procedure and the packet switched domain registration procedure may be performed in parallel by invoking a location update procedure for circuit switched domain registration and routing area update procedure for packet switched domain registration.

In an implementation, the circuit switched call setup procedure may comprise a circuit switched fallback procedure. The first radio access technology may be used in an evolved packet network. The first radio access technology may comprise Long Term Evolution (LTE) radio access technology. The second radio access technology may be used in at least one of a circuit switched network and a packet switched network. The second network may comprise a UMTS based network or a GSM based network.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution and a component may be localized on one computer and/or distributed between two or more computers. In addition, these components may execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which may be a wired terminal or a wireless terminal. A terminal may also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, edma2000 and UMB are described in documents from an organization named “3rd Generation Partnership Project 2” (3GPP2). Further, such wireless communication systems may additionally include peer-to-peer(e.g., mobile-to-mobile) ad hoc network systems often using unpaired unlicensed spectrums, 802.xx wireless LAN, BLUETOOTH and any other short- or long-range, wireless communication techniques.

It should be understood and appreciated that various aspects or features will be presented in terms of systems that may include a number of devices, components, modules, and the like. It should also be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor may read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method of wireless communication, comprising:
determining whether a device is switching from a first radio access technology to a second radio access technology to perform a circuit switched call setup process;
determining whether at least one of a circuit switched domain registration procedure and a packet switched domain registration procedure is to be performed on the second radio access technology;
performing the circuit switched domain registration procedure or a circuit switched call setup procedure in parallel with the packet switched domain registration procedure based on the determination that the device is switching radio access technologies to implement the circuit switched call setup process; and
performing the circuit switched domain registration procedure in series with the packet switched domain registration procedure based on the determination that the device is not switching radio access technologies to implement the circuit switched call setup process.

2. The method of claim 1, wherein the circuit switched domain registration procedure and the packet switched domain registration procedure are performed in series by invoking a combined routing area update procedure.

3. The method of claim 1, wherein the circuit switched domain registration procedure and the packet switched domain registration procedure are performed in parallel by invoking a location update procedure for circuit switched domain registration and routing area update procedure for packet switched domain registration.

4. The method of claim 1, wherein the circuit switched call setup procedure comprises a circuit switched fallback procedure.

5. The method of claim 1, wherein the device comprises user equipment.

6. The method of claim 1, wherein the device is configured to communicate with an evolved Node B (eNB) using the first radio access technology.

7. The method of claim 1, wherein the first radio access technology is used in an evolved packet network.

8. The method of claim 1, wherein the first radio access technology comprises Long Term Evolution (LTE) radio access technology.

9. The method of claim 1, wherein the device is configured to communicate with a base station using the second radio access technology.

10. The method of claim 1, wherein the second radio access technology is used in at least one of a circuit switched network and a packet switched network.

11. The method of claim 1, wherein the second network comprises a Universal Mobile Telecommunications System (UMTS) based network or a Global System for Mobile Communications (GSM) based network.

12. An apparatus for wireless communication, comprising:
a processing system configured to:
determine whether a device is switching from a first radio access technology to a second radio access technology to perform a circuit switched call setup process;
determine whether at least one of a circuit switched domain registration procedure and a packet switched domain registration procedure is to be performed on the second radio access technology;
perform the circuit switched domain registration procedure or a circuit switched call setup procedure in parallel with the packet switched domain registration procedure based on the determination that the device is switching radio access technologies to implement the circuit switched call setup process; and
perform the circuit switched domain registration procedure in series with the packet switched domain registration procedure based on the determination that the device is not switching radio access technologies to implement the circuit switched call setup process.

13. The apparatus of claim 12, wherein the circuit switched domain registration procedure and the packet switched domain registration procedure are performed in series by invoking a combined routing area update procedure.

14. The apparatus of claim 12, wherein the circuit switched domain registration procedure and the packet switched domain registration procedure are performed in parallel by invoking a location update procedure for circuit switched domain registration and routing area update procedure for packet switched domain registration.

15. The apparatus of claim 12, wherein the circuit switched call setup procedure comprises a circuit switched fallback procedure.

16. The apparatus of claim 12, wherein the device comprises user equipment.

17. The apparatus of claim 12, wherein the device is configured to communicate with an evolved Node B (eNB) using the first radio access technology.

18. The apparatus of claim 12, wherein the first radio access technology is used in an evolved packet network.

19. The apparatus of claim 12, wherein the first radio access technology comprises Long Term Evolution (LTE) radio access technology.

20. The apparatus of claim 12, wherein the device is configured to communicate with a base station using the second radio access technology.

21. The apparatus of claim 12, wherein the second radio access technology is used in at least one of a circuit switched network and a packet switched network.

22. The apparatus of claim 12, wherein the second network comprises a Universal Mobile Telecommunications System (UMTS) based network or a Global System for Mobile Communications (GSM) based network.

23. An apparatus for wireless communication, comprising:
means for determining whether a device is switching from a first radio access technology to a second radio access technology to perform a circuit switched call setup process;
means for determining whether at least one of a circuit switched domain registration procedure and a packet switched domain registration procedure is to be performed on the second radio access technology;
means for performing the circuit switched domain registration procedure or a circuit switched call setup procedure in parallel with the packet switched domain registration procedure based on the determination that the device is switching radio access technologies to implement the circuit switched call setup process; and
means for performing the circuit switched domain registration procedure in series with the packet switched domain registration procedure based on the determination that the device is not switching radio access technologies to implement the circuit switched call setup process.

24. The apparatus of claim 23, wherein the circuit switched domain registration procedure and the packet switched domain registration procedure are performed in series by invoking a combined routing area update procedure.

25. The apparatus of claim 23, wherein the circuit switched domain registration procedure and the packet switched domain registration procedure are performed in parallel by invoking a location update procedure for circuit switched domain registration and routing area update procedure for packet switched domain registration.

26. The apparatus of claim 23, wherein the circuit switched call setup procedure comprises a circuit switched fallback procedure.

27. The apparatus of claim 23, wherein the device comprises user equipment.

28. The apparatus of claim 23, wherein the device is configured to communicate with an evolved Node B (eNB) using the first radio access technology.

29. The apparatus of claim 23, wherein the first radio access technology is used in an evolved packet network.

30. The apparatus of claim 23, wherein the first radio access technology comprises Long Term Evolution (LTE) radio access technology.

31. The apparatus of claim 23, wherein the device is configured to communicate with a base station using the second radio access technology.

32. The apparatus of claim 23, wherein the second radio access technology is used in at least one of a circuit switched network and a packet switched network.

33. The apparatus of claim 23, wherein the second network comprises a Universal Mobile Telecommunications System (UMTS) based network or a Global System for Mobile Communications (GSM) based network.

34. A computer program product, comprising:
a computer-readable medium comprising code executable by an apparatus to:
determine whether a device is switching from a first radio access technology to a second radio access technology to perform a circuit switched call setup process;
determine whether at least one of a circuit switched domain registration procedure and a packet switched domain registration procedure is to be performed on the second radio access technology;
perform the circuit switched domain registration procedure or a circuit switched call setup procedure in parallel with the packet switched domain registration procedure based on the determination that the device is switching radio access technologies to implement the circuit switched call setup process; and
perform the circuit switched domain registration procedure in series with the packet switched domain registration procedure based on the determination that the device is not switching radio access technologies to implement the circuit switched call setup process.

35. The computer program product of claim 34, wherein the circuit switched domain registration procedure and the packet switched domain registration procedure are performed in series by invoking a combined routing area update procedure.

36. The computer program product of claim 34, wherein the circuit switched domain registration procedure and the packet switched domain registration procedure are performed in parallel by invoking a location update procedure for circuit switched domain registration and routing area update procedure for packet switched domain registration.

37. The computer program product of claim 34, wherein the circuit switched call setup procedure comprises a circuit switched fallback procedure.

38. The computer program product of claim 34, wherein the device comprises user equipment.

39. The computer program product of claim 34, wherein the device is configured to communicate with an evolved Node B (eNB) using the first radio access technology.

40. The computer program product of claim 34, wherein the first radio access technology is used in an evolved packet network.

41. The computer program product of claim 34, wherein the first radio access technology comprises Long Term Evolution (LTE) radio access technology.

42. The computer program product of claim 34, wherein the device is configured to communicate with a base station using the second radio access technology.

43. The computer program product of claim 34, wherein the second radio access technology is used in at least one of a circuit switched network and a packet switched network.

44. The computer program product of claim 34, wherein the second network comprises a Universal Mobile Telecommunications System (UMTS) based network or a Global System for Mobile Communications (GSM) based network.
